(19) United States
(12) Patent Application Publication
(10) Pub. No.: US 2018/0115584 A1
(43) Pub. Date: Apr. 26, 2018

(54) COLOR IMAGE RAY TRANSFORM TECHNIQUE FOR DETECTING PHISHING WEB PAGES

(71) Applicant: King Abdulaziz City for Science and Technology, Riyadh (SA)

(72) Inventors: Alaa Mohammed Alhumaisan, Riyadh (SA); Mansour Abdulrahman Alsaleh, Riyadh (SA); Noura Nassir Alomar, Riyadh (SA)

(21) Appl. No.: 15/333,647

(22) Filed: Oct. 25, 2016

(51) Int. Cl. H04L 29/06; G06K 9/46

(52) U.S. Cl. CPC H04L 63/1483; G06K 9/4652

(57) ABSTRACT

The present disclosure generally relates to information security and, more particularly, to systems and methods implementing color image ray transform (IRT) for detecting phishing web pages. A focus is comparing the features of a questionable website to features of a legitimate website. Detection of a phishing website using color IRT includes: requesting access, on at least one computing device, to a web page having a Universal Resource Locator (URL); comparing, using the at least one computing device, the URL of the requested web page to a reference URL within a database stored in a memory; determining, using the at least one computing device, that the URL of the requested web page matches the reference URL; and generating, using the at least one computing device, a message that the web page is legitimate when there is a match between the URL of the requested web page and the reference URL.

### FIELD OF THE INVENTION

The present disclosure generally relates to information security and, more particularly, to systems and methods implementing color image ray transform (IRT) for detecting phishing web pages.

### BACKGROUND

The proliferation of phishing attacks on the web has caused significant increases in the number of security and privacy breaches. Launching phishing attacks can involve malicious individuals creating fake web pages which are designed to include content similar to what exists in original web-based systems. These web pages are then used to deceive users and steal their private information.

In response to the seriousness of phishing attacks, approaches have been proposed for detecting or preventing phishing attacks. However, the need for better approaches is growing as phishing attacks are evolving and becoming more sophisticated.

### SUMMARY

In an aspect of the disclosure, a method for detecting phishing web pages, comprises: requesting access, using at least one computing device, to a web page having a Universal Resource Locator (URL); comparing, using the at least one computing device, the URL of the requested web page to a reference URL within a database stored in a memory; determining, using the at least one computing device, that the URL of the requested web page matches the reference URL; and generating, using the at least one computing device, a message that the web page is legitimate when there is a match between the URL of the requested web page and the reference URL.

In an aspect of the disclosure, a system for detecting phishing web pages, comprises: a CPU, a computer readable memory and a computer readable storage media; first program instructions to load a Universal Resource Locator (URL) of a web page into a web browser to access a loaded website; second program instructions to capture a screenshot of the loaded website; third program instructions to analyze the screenshot with an image ray transform (IRT) technique; fourth program instructions to extract features from the screenshot using a feature extraction or detection technique such as a Hough transform, or any type of extraction technique including an IRT technique alone, an IRT technique along with a Hough transform or any other feature extraction technique; and fifth program instructions to compare the extracted features to a reference image, wherein the first, second, third, fourth and fifth program instructions are stored on the computer readable storage media for execution by the CPU via the computer readable memory. If the extraction technique is an IRT technique alone, then there may be no need to extract features with an IRT technique as a second step.

In an aspect of the disclosure, a computer program product comprising a computer readable storage medium having program instructions embodied therewith, and the program instructions are readable by a computing device to cause the computing device to: enter a Universal Resource Locator (URL) of a web page within a computing network; evaluate the entered URL to a reference URL stored within the computing network; determine if the entered URL matches the reference URL; present a message that the web page is legitimate if the entered URL matches the reference URL; and load the entered URL into a web browser to access a loaded website if the entered URL does not match the reference URL.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative infrastructure for implementing the color IRT technique for detecting phishing web pages in accordance with aspects of the invention.

FIG. 2 shows an exemplary flowchart for detecting phishing web pages in accordance with aspects of the present invention.

### DETAILED DESCRIPTION

The present disclosure generally relates to information security and, more particularly, to systems and methods implementing color image ray transform (IRT) for detecting phishing web pages. In embodiments, the detection of phishing web pages includes checking if a Universal Resource Locator (URL) of a web page is legitimate by requesting to open the URL, which generates a comparison of the requested URL to a reference URL that is known to be legitimate. Once it is determined that the requested URL is legitimate by the comparison, a message is presented indicating that the web page is legitimate, i.e., not a phishing website.

In embodiments, if the requested URL does not match the reference URL, the detection of phishing web pages continues by loading the requested URL into a web browser to access a loaded website. After the requested URL is loaded into the web browser and the loaded website is accessed, a screenshot of the loaded website is captured. The screenshot is analyzed by applying an image ray transform (IRT) technique to the screenshot. Features found in the screenshot by the IRT technique are extracted.

The features from the screenshot are evaluated in relation to an image known to be legitimate. A degree of similarity between the features and the image is determined, which is then compared to a threshold. In embodiments, if the degree of similarity is smaller than the threshold, a message that the web page is legitimate is generated and presented. If the degree of similarity is greater than the threshold, a message that the web page may not be legitimate is presented.

More specifically, the present disclosure is directed to notifying a user that a web page may or may not be legitimate. Legitimacy of a web page is determined through multiple approaches, including checking the URL and checking the features of the loaded website. Checking the features of the loaded website includes applying an image-comparison approach using a technique called color IRT for automatically detecting phishing web pages. Color IRT is a technique capable of extracting cylindrical and circular structures that may not often be found by other techniques. Additionally, the color IRT technique uses a pixel-based ray-tracing technique and analogizes the progression of light through a mathematical function, such as Snell's Law, to trace rays through an image, like the screenshot of the loaded website, which would be the web page that is being analyzed to determine if it is a phishing web page. Rays from the color IRT technique react to and outline certain structural features present in the image.

Although the systems and methods described hereafter are with regard to exemplary methods, and/or computer program products, it should be understood that other implementations are also contemplated by the present disclosure as described herein. For example, other devices, systems, appliances, and/or computer program products according to embodiments of the present disclosure will be or become apparent to one of ordinary skill in the art upon review of the drawings and detailed description. It is intended that all such additional other devices, systems, appliances, processes, and/or computer program products be included within the scope of the present disclosure.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects. Furthermore, aspects of the present disclosure may take the form of a computer program product embodied in one or more computer readable storage medium(s) having computer readable program code embodied thereon.

The computer readable storage medium (or media) having computer readable program instructions thereon causes one or more computing processors to carry out aspects of the present disclosure. The computer readable storage medium can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

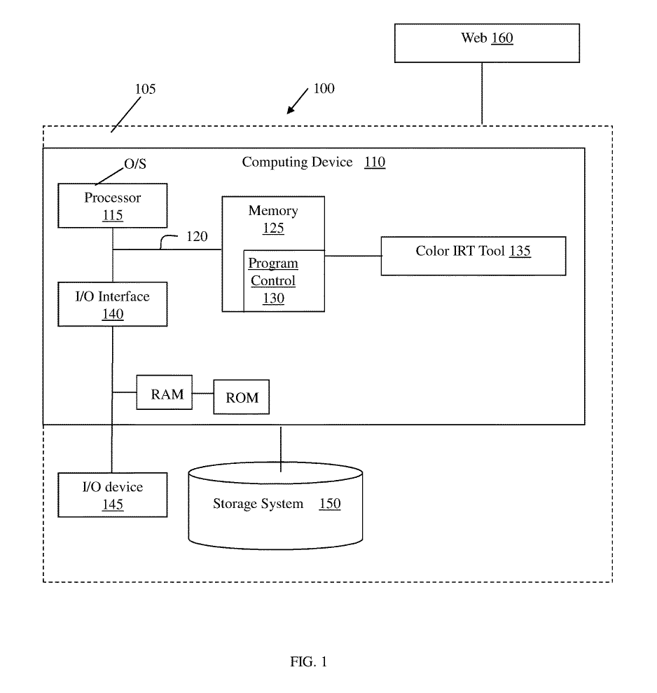

A non-exhaustive list of more specific examples of the computer readable storage medium includes the following non-transitory signals: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. The computer readable storage medium is not to be construed as transitory signals per se; instead, the computer readable storage medium is a physical medium or device which stores the data. The computer readable program instructions may also be loaded onto a computer, for execution of the instructions, as shown in FIG. 1.

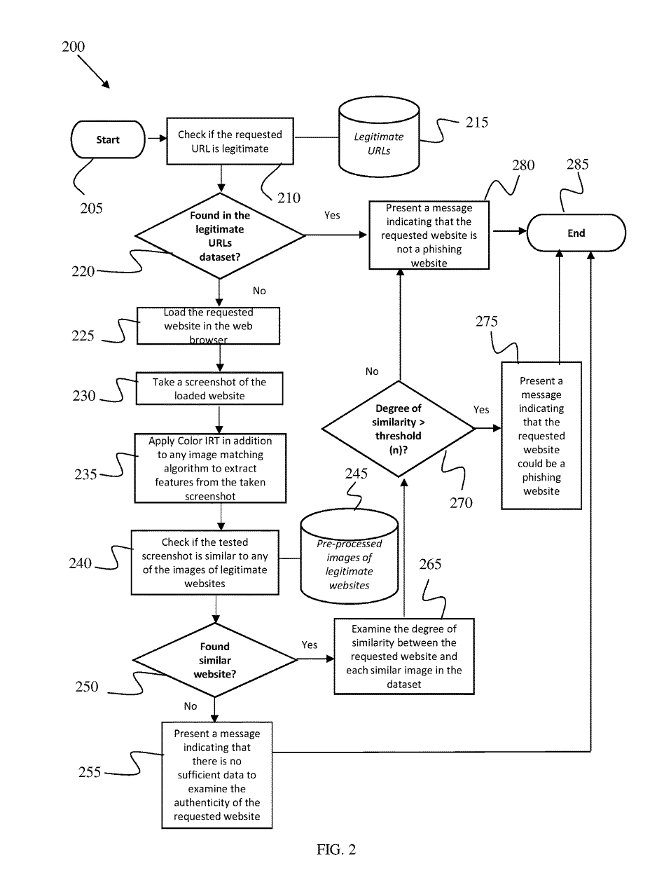

FIG. 1 shows a computer infrastructure 100 for implementing the steps in accordance with aspects of the disclosure. To this extent, the infrastructure 100 can implement the detection of phishing web pages shown in FIG. 2, e.g., checking the URL and applying color IRT to extract features from the taken screenshot and an image matching algorithm to compare and match the extracted features to a legitimate image. The infrastructure 100 includes a server 105 or other computing system that can perform the processes described herein. In particular, the server 105 includes a computing device 110. The computing device 110 can be resident on a network infrastructure or computing device of a third party service provider (any of which is generally represented in FIG. 1). Additionally, the infrastructure 100 is in communication with the web 160 so that the web pages in question can be accessed. The web 160 can represent the World Wide Web, the Internet and/or any other computer networks that allow people to share information.

The computing device 110 includes a processor 115 (e.g., CPU), memory 125, an I/O interface 140, and a bus 120. The memory 125 can include local memory employed during actual execution of program code, bulk storage, and cache memories which provide temporary storage of at least some program code in order to reduce the number of times code which are retrieved from bulk storage during execution. In addition, the computing device includes random access memory (RAM), a read-only memory (ROM), and an operating system (O/S).

The computing device 110 is in communication with external I/O device/resource 145 and storage system 150. For example, I/O device 145 can comprise any device that enables an individual to interact with computing device 110 (e.g., user interface) or any device that enables computing device 110 to communicate with one or more other computing devices using any type of communications link. The external I/O device/resource 145 may be for example, a handheld device, PDA, handset, keyboard etc.

In general, processor 115 executes computer program code (e.g., program control 130), which can be stored in memory 125 and/or storage system 150. Further, databases containing the reference URLs and the reference images, i.e., copies of the legitimate URLs and legitimate images of the original web pages, can be stored in the storage system 150. Moreover, in accordance with aspects of the invention, program control 130 controls a color image ray transform (IRT) tool 135, which performs the detection of phishing web pages described herein. The color IRT tool 135 can be implemented as one or more program codes in program control 130 stored in memory 125 as separate or combined modules. Additionally, the color IRT tool 135 may be implemented as separate dedicated processors or a single or several processors to provide the function of this tool. While executing the computer program code, the processor 115 can read and/or write data to/from memory 125, storage system 150, and/or I/O interface 140. The program code executes the processes of the invention. The bus 120 provides a communications link between each of the components in computing device 110.

The color IRT tool 135 is utilized to perform the detection of phishing web pages shown in FIG. 2. For example, the different checks, analysis, comparisons and evaluations shown in FIG. 2 can be used to evaluate whether a potential Universal Resource Locator (URL) of a web page is legitimate, or instead is not legitimate, e.g., a phishing webpage. In an illustrative example, the color IRT tool 135 checks, analyzes, compares, evaluates and assesses the legitimacy of a web page as shown in FIG. 2. For example, a user requests to open a URL of a web page. Once the user attempts to open the requested URL, the detection process of FIG. 2 is applied against the URL. The color IRT tool 135 begins the assessment of the legitimacy of the web page by checking the requested URL against a reference URL which has been predetermined to be legitimate. If the color IRT tool 135 determines that the requested URL is legitimate, the detection process of FIG. 2 can be concluded and the user is presented with a generated message 280 which indicates to the user that the requested web page is not a phishing website.

If the color IRT tool 135 determines that the requested URL may not be legitimate, i.e., does not match the reference URL, the color IRT tool 135 continues the detection of FIG. 2. The color IRT tool 135 loads the requested URL into a web browser to reach and load a website, such as a web browser associated with the web 160, and captures a screenshot of the loaded website, which is the web page that is being analyzed to determine if it is a phishing web page. Features from the screenshot found by the IRT are extracted. These features are then evaluated against features from a legitimate image of the web page. A degree of similarity between the features of the screenshot and the features of the legitimate image of the web page is determined, and the degree of similarity is compared to a threshold. If the degree of similarity is less than the threshold, a message that the web page is legitimate is generated and presented to the user. If the degree of similarity is greater than the threshold, a message that the web page may not be legitimate is generated and presented to the user.

Specifically, the color IRT tool 135 evaluates the legitimacy of a web page using a combination of components, which are shown in FIG. 2. A component of the color IRT tool 135 involves checking the correctness and accuracy of an entered and/or requested URL by comparing the requested URL to a reference URL that has been predetermined to be correct. If the requested URL is correct, the user will be notified by a message that the requested URL and accompanying web page is correct and that the user can safely proceed. Therefore, the user can proceed by loading the requested website in the client side. However, the user maintains the ability to proceed to the requested web page at all times if the user so desires, even if the requested URL is determined to be incorrect and the user does not receive the message.

Another component of the color IRT tool 135 involves the application of a color image ray transform (IRT) technique. Specifically, a URL of a web page is loaded into a web browser to reach and load a website, such as a web browser associated with web 160. A screenshot of the loaded website is captured so that an image analysis, including the IRT technique, can be applied in order to determine the legitimacy of the web page. During the image analysis, various features detected by the IRT technique are extracted from the taken screenshot. The extracted features from the screenshot are compared to features in a reference image, which is a predetermined image of the legitimate web page, by an image matching algorithm. It is noted that all techniques, such as checking the URL and the color IRT technique, can be applied as a plug-in in the computing infrastructure 100.

In embodiments, the IRT technique of the color IRT tool 135 is an image analysis technique which is capable of extracting cylindrical and circular structures, among other structures, that are present in the screenshot of the loaded website. The IRT technique of the color IRT tool 135 can be a color IRT technique and may implement a pixel-based ray-tracing technique during its execution. Further, the IRT technique analogizes a progression of light through a mathematical function to trace rays through an image. The mathematical function is derived from Snell's Law. Therefore, the rays from the IRT technique can react to and outline certain structural features present in an image, such as the screenshot of the loaded website. The response of the IRT technique includes an edge detection towards circular and curvative and curve-like shapes. Therefore, the IRT technique makes it suitable for a diversity of applications.

In comparison to the IRT technique, the color IRT technique is a further technique for feature extraction that extends the original IRT technique to use illumination information in addition to geometrical information. A benefit of the color IRT technique is that it can detect curved objects. The color IRT technique introduces color information to the IRT, which is a further benefit since the IRT technique works on greyscale images. Therefore, the color IRT technique increases the robustness of IRT technique analysis by enabling selective feature extraction through detecting or ignoring objects with colors of interest.

During the execution of the color IRT technique, the IRT aspect will be redirected towards certain objects through the use of red-green-blue (RGB) channels. Color information can be an important indicator to distinguish between different objects in the human vision system. Ignoring color information can imply losing a valuable source of information. Therefore, color information is beneficial.

Usually the extension of methods from greyscale space, as found in IRT, to color space, as found in color IRT, involves the migration from scalar values to vector values. At least three-dimensional vectors for a straightforward transition to the three components of the RGB system are needed. In color IRT, an aim is to represent color information in a way that preserves a single-valued pixel structure of the image in order to be able to generalize the conventional greyscale IRT to the color IRT while preserving the simplicity and low cost of the IRT. While there may be interest in a correlation between the three components RGB in the RGB space, the three color components RGB can be analyzed sequentially and retain a single-value pixel structure. Therefore, usage of RGB system in the color IRT was chosen and can be used as a baseline for color extension to the IRT to generate the color IRT technique.

Color IRT can process an image in a similar way that the conventional IRT processes can image. However, before processing the image, such as the screenshot of the loaded website, the color IRT technique can view the problem from a different angle. Specifically, instead of going through all the curvative and curve-like shapes in the image, the color IRT technique simply emphasizes the targeted objects by adjusting the relevant band or bands of colors in the image. The adjustment by the color IRT technique may put the focus on the targeted objects in the image or alternatively may imply ignoring the undesired objects. Afterwards, the rays of the color IRT technique can be projected onto the image in a similar manner as they are projected onto the greyscale image in the conventional IRT. Pixel intensity of the color IRT technique is represented as a result of the linear summation of the three color components multiplied by a weight factor as shown in equation (1).

$${V}_{color} = {k}_{r} * R + {k}_{g} * G + {k}_{b} * B \qquad ( 1 )$$

V_{Color} is a converted pixel value and the R, G and B represent the value of the red, green and blue components, respectively, in a single pixel in the original image. The coefficients kᵣ, k_{g} and k_{b} each represent the contribution of each channel component. Further, they are the parameters that can provide a meaning of controlling the focus of the IRT on certain colored objects.

The propagation of waves like sound or light is modeled via rays of the color IRT technique. A main interest is in the response in direction of the rays when propagating from one medium to another. A medium in physics can refer to a material through which light passes, and different materials can have different properties that affect the interaction with rays. When light travels through a medium, it can continue in a straight line until the light encounters a new medium with different properties. Upon encountering a new medium, the light can respond by a change in direction depending on the refractive indices of the two media.

An optical medium can be a material through which electromagnetic waves can propagate. In order to apply optic laws on an image, the image can be represented in a format that is capable of showing a propagation of the rays through the image while preserving the original information in the image. A simple analogy can be representing the image as a matrix of glass blocks, where each glass block resembles a pixel. To preserve the characteristics of the image, the refractive index of each glass block can be derived in relation to the pixel intensity using a straightforward method if need be. The refractive index can be a ratio of the intensity to the maximum intensity multiplied by the maximum possible refractive index nₘₐₓ. Then, the refractive indices are evenly spaced in the range [1−nₘₐₓ]. The maximum refractive index is one of the different parameters set for testing, and it can control an interaction between a transform and the image and guides the transform towards highlighting certain features. The function representing the refractive index nᵢ is shown below in equation (2).

$${n}_{i} = 1 + ( \frac{i}{255} ) * ( {n}_{max} - 1 ) \qquad ( 2 )$$

It is noted that several aspects of the invention can require the use of a computer network, computer system, and computing devices. For example, the entering of a Universal Resource Locator (URL) of a web page can require a computing environment so that the URL can be entered and executed. As another example, evaluating the entered URL against a reference URL which is stored within the computing network, such as in a database, can require a computing environment. As a further example, determining if the entered URL matches the reference URL can require a computing network. Additionally, loading the entered URL into a web browser if the entered URL does not match the reference URL, can require a computing network. Capturing a screenshot of the loaded website and applying the IRT technique to the screenshot, can require a computing network. Further, extracting the features from the screenshot, evaluating the features to features from a legitimate image, determining a degree of similarity between the features and the legitimate image features, comparing the degree of similarity to a threshold and generating and presenting a message to the user concerning the legitimacy of the web page can all require the use of a computing network.

The color IRT technique highlights the features from the images so that a degree of similarity between images of the two given websites can be generated. The color IRT technique can be preferable for the following reasons: (1) color IRT can be superior at extracting circular objects compared to other image-feature extraction techniques that often capable of extracting these shapes; (2) The color IRT approach can be based on simple physical laws such as Snell's Law, which can make it easier to understand and flexible to be adapted. Further, color IRT uses a pixel-based ray-tracing technique and analogizes the progression of light through Snell's Law to trace rays through an image; rays then react to and outline certain structural features; (3) color IRT can use geometrical information in addition to color information for detecting circular objects. Most of the object extraction techniques uses either geometrical information or color information; (4) color IRT can be used in combination with any other object detection techniques for detecting other non-circular objects; and (5) simplicity and applicability are the key factors in this proposed approach that allows further extendibility.

FIG. 2 shows an exemplary flowchart for implementing the detection of phishing web pages. As an overview, a user attempts to open a URL in a web browsing system, the process 200 starts by checking the correctness of the entered URL. If the URL is correct, the user will be notified to proceed by loading the requested website in the client side. If the URL is not confirmed to be a real one, the process 200 sends a request to the web page, e.g., website, being accessed and converts it to an image before loading it in the web browser. However, the process 200 can load the URL into a web browser to access a website and then take a screenshot of the loaded web page, i.e., the loaded website. Therefore, the terms web page and website are used interchangeably.

The image is then passed to the second component of the system and/or process 200 which extracts a set of features that help in distinguishing between original and fake web pages. The process 200 further analyzes the obtained image of the web page being requested by running an image-comparison algorithm which examines the degree of similarity between the web page being requested and each image stored in dataset of pre-collected and pre-processed images of original websites. Once the image-comparison algorithm identifies that the degree of similarity between the examined website and any of the images stored in a dataset is greater than a given threshold, the invented technique generates and presents a message warning the user that the website he/she is requesting could be a phishing website. Once a user is notified about the risks associated with accessing the requested URL, the user can decide whether to proceed to the requested website by displaying the blocked content or not.

The system and/or process 200 can be used in a variety of situations such as detecting phishing attacks, security, image-comparison techniques, computer vision, image processing, and feature extraction in photo-based user authentication systems and processes, among other examples.

Referring now to FIG. 2, at step 205, the process 200 begins with checking if the requested URL is legitimate at step 210. Step 210 requests a URL of a web page. Then this requested URL is evaluated to a reference URL within a database stored in a memory as shown in step 220. As shown in FIG. 2, the legitimate URLs, i.e., URLs that have been determined to be legitimate and which are used as reference URLs, are stored in database 215. Database 215 can be stored in a storage system 150 of the computer infrastructure 100 shown in FIG. 1.

Continuing with step 220, if the requested URL is found in the URL dataset, i.e., a match is found between the requested URL and the reference URL, the process 200 proceeds to step 280. At step 280, a message is generated and presented to the user indicating that the requested website (web page) is not a phishing website. The message can take any form that is suitable to the user, such as displaying the message on a screen of the computing device, or any other form that is suitable to notify the user that the web page is legitimate.

On other hand, if at step 220 the requested URL is not found in the URL dataset, i.e., there is no match between the requested URL and the reference URL, the process 200 proceeds to step 225. At step 225, the second component of the detection for phishing web pages begins. At step 225 of process 200, the requested website, i.e., the requested URL, is loaded into a web browser of the computer infrastructure 100 to access a website. Any web browser that allows for the requested URL to be entered and executed can be implemented.

At step 230, a screenshot of the loaded website is captured and/or taken. The screenshot can be an entire image of the loaded website, and/or a portion of the loaded website, depending on the user's needs. Additionally, the screenshot of the loaded website is a natural image, that is, the screenshot of the web site is taken as the website appears. More specifically, if the loaded website displays various colors, the screenshot will capture these colors. Further, the screenshot of the loaded website can be analyzed in color, greyscale, or black and white.

By having a screenshot of the loaded website, the process 200 can proceed to step 235, which includes the application of the color IRT technique to the screenshot of the loaded website. The color IRT technique implements various approaches to accomplish feature detection. These various approaches include a pixel-based ray-tracing technique and further analogizing a progression of light through Snell's Law to trace rays through an image. The rays of the color IRT technique then react to and outline certain structural features. Therefore, the color IRT technique of step 235 is capable of extracting cylindrical and circular structures from the screenshot of the loaded website, which are often not found by other feature detection techniques.

Once the color IRT technique is applied and the structural features are extracted from the screenshot at 235 an image matching algorithm compares the extracted features of the screenshot to features from an image of the legitimate web page. The features from the image of the legitimate web page, i.e., a reference image and reference features extracted from the reference image, are stored in database 245. Similar to database 215 which stores the legitimate URLs, database 245 can be stored in the storage system 150 of the computer infrastructure 100 shown in FIG. 1.

At step 240, the screenshot of the loaded website is tested to determine if any of the extracted images from the screenshot are similar to any of the images of legitimate websites stored in database 245. This evaluation at step 240 includes the implementation of the image matching algorithm to compare the extracted features of the screenshot to features from an image of the legitimate web page. Running the image matching algorithm examines the degree of similarity between the features of the web page being requested, which is the web page being analyzed to determine whether it is a phishing web page, and the features extracted from the legitimate image stored in the database 245 of pre-collected images of original websites.

If the requested website is found similar at step 250, i.e., then the requested website is further examined for a degree of similarity in accordance with step 265. However, if the requested website is not similar, then in accordance with step 255 there is no sufficient data to examine the authenticity of the requested website and the process ends with step 285. The database of legitimate URLs can be database 215 or any additional database which also stores legitimate URLs. Database 215 and any additional database can be stored in the storage system 150 of the computer infrastructure 100 shown in FIG. 1. On the other hand, if the requested website is found similar to the legitimate web page at step 250, i.e., the requested website is similar to the legitimate web page, the data from image matching algorithm is analyzed. That is, at step 265, a degree of similarity between the requested web page and any of the images stored in the database 245 is determined. More specifically, the extracted features of the requested web page, which is the loaded website, are compared against features from the image of the legitimate web page.

At step 270, this degree of similarity is examined against a given threshold. Depending on the analysis of step 270, the user is either informed that the requested website could be legitimate or could be a phishing web page. For example, if the degree of similarity is less than the threshold, the message of step 280 is generated and then presented to the user, e.g., “The requested web page is not a phishing website.” On the other hand, if the degree of similarity is greater than the threshold, the message of step 275 can inform the user that the requested web page could be a phishing website, i.e., “The web page may not be legitimate.” However, regardless of the message presented to the user, the user can proceed to the requested website if they so desire. The process 200 ends with step 285.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for detecting phishing web pages, comprising:
requesting access, using at least one computing device, to a web page having a Universal Resource Locator (URL);
comparing, using the at least one computing device, the URL of the requested web page to a reference URL within a database stored in a memory;
determining, using the at least one computing device, that the URL of the requested web page matches the reference URL;
generating, using the at least one computing device, a message that the web page is legitimate when there is a match between the URL of the requested web page and the reference URL, wherein when the URL of the requested web page does not match the reference URL, the method further comprises:
loading, using the at least one computing device, the URL of the requested web page into a web browser to access a loaded website; and
capturing, using the at least one computing device, a screenshot of the loaded website;
applying, using the at least one computing device, a color image ray transform (IRT) to the screenshot; and
extracting, using the at least one computing device, features from the screenshot highlighted by the IRT.

2. (canceled)

3. (canceled)

4. The method of claim 1, wherein the color IRT implements pixel-based ray-tracing and analogizes a progression of light through Snell's Law to trace rays throughout the screenshot.

5. The method of claim 4, wherein the rays react to and outline the features within the screenshot.

6. The method of claim 1, further comprising:
evaluating, using the at least one computing device, the features within the screenshot to an image within a database stored in a memory;
determining, using the at least one computing device, a degree of similarity between the features and the image; and
comparing, using the at least one computing device, the degree of similarity to a threshold.

7. The method of claim 6, wherein the message that the web page is legitimate is generated when the degree of similarity is less than the threshold.

8. The method of claim 7, wherein a message that the web page may not be legitimate is generated when the degree of similarity is greater than the threshold.

9. A system for detecting phishing web pages, comprising:
a CPU, a computer readable memory and a computer readable storage media;
first program instructions to load a Universal Resource Locator (URL) of a web page into a web browser to access a loaded website;
second program instructions to capture a screenshot of the loaded website;
third program instructions to analyze the screenshot with an image ray transform (IRT) technique;
fourth program instructions to extract features from the screenshot found by the IRT; and
fifth program instructions to compare the extracted features to a reference image,
wherein
the first, second, third, fourth and fifth program instructions are stored on the computer readable storage media for execution by the CPU via the computer readable memory.

10. The system of claim 9, wherein the IRT technique is a color IRT.

11. The system of claim 10, wherein the color IRT technique implements pixel-based ray-tracing and analogizes a progression of light through Snell's Law to trace rays throughout the screenshot.

12. The system of claim 11, wherein the rays react to and outline the features within the screenshot.

13. A computer program product comprising a computer readable storage medium having program instructions embodied therewith, and the program instructions are readable by a computing device to cause the computing device to:
enter a Universal Resource Locator (URL) of a web page within a computing network;
evaluate the entered URL to a reference URL stored within the computing network;
determine if the entered URL matches the reference URL;
present a message that the web page is legitimate if the entered URL matches the reference URL;
load the entered URL into a web browser to access a loaded website if the entered URL does not match the reference URL;
capturing a screenshot of the loaded website;
applying an image ray transform (IRT) to the screenshot; and
extracting, using the computing device, features from the screenshot found by the IRT.

14. (canceled)

15. The computer program product of claim 13, wherein the IRT is a color IRT.

16. The computer program product of claim 15, wherein the color IRT implements pixel-based ray-tracing and analogizes a progression of light through Snell's Law to trace rays throughout the screenshot.

17. The computer program product of claim 16, wherein the rays react to and outline the features within the screenshot.

18. The computer program product of claim 13, further comprising:
evaluating the features to an image;
determining a degree of similarity between the features and the image; and
comparing the degree of similarity to a threshold.

19. The computer program product of claim 18, wherein the message that the web page is legitimate is presented when the degree of similarity is greater than the threshold.

20. The method of claim 8, wherein the image comprises a legitimate image of an original web page.

21. The method of claim 20, wherein the color IRT includes an edge detection towards circular and curvative and curve-like shapes.

22. The system of claim 12, wherein the rays react to and outline the features within the screenshot comprises the color IRT technique emphasizing targeted objects in the screenshot by adjusting bands of colors in the screenshot.

23. The system of claim 22, wherein the color IRT technique comprises a pixel intensity which is a result of a linear summation of three color components multiplied by a weight factor.
